(19) United States
(12) Patent Application Publication
(10) Pub. No.: US 2016/0185947 A1
(43) Pub. Date: Jun. 30, 2016

(54) GOLF BALL MATERIAL AND METHOD OF MANUFACTURE

(71) Applicant: BRIDGESTONE SPORTS CO., LTD., Tokyo (JP)

(72) Inventors: Takanori TAGO, Chichibushi (JP); Atsushi NANBA, Chichibushi (JP)

(73) Assignee: BRIDGESTONE SPORTS CO., LTD., Tokyo (JP)

(21) Appl. No.: 14/930,842

(22) Filed: Nov. 3, 2015

(30) Foreign Application Priority Data
Dec. 25, 2014 (JP) 2014-261760

(51) Int. Cl. C08L 33/08; A63B 37/00; C08L 33/02

(52) U.S. Cl. CPC C08L 33/08; C08L 33/02; A63B 37/0051

(57) ABSTRACT

A golf ball material includes specific amounts of two base resins: (A) an olefin-unsaturated carboxylic acid-unsaturated carboxylic acid ester ternary copolymer, or a metal neutralization product thereof, having a specific weight-average molecular weight, acid content and ester content, and (B) an olefin-acrylic acid random binary copolymer, or a metal neutralization product thereof, having a specific weight-average molecular weight and acid content, and additionally includes (C) a basic inorganic metal compound, and (D) an anionic surfactant. Resins A and B have specific melt flow rates (MFR) and a specific MFR difference therebetween. Molded products obtained from the overall composition have a specific hardness. A method of producing such a material is also provided. In golf balls, this material is able to maintain a good ball rebound and durability, has a good flowability during molding, and moreover is capable of minimizing molding defects due to gas evolution, increasing productivity.

### CROSS-REFERENCE TO RELATED APPLICATION

This non-provisional application claims priority under 35 U.S.C. §119(a) on Patent Application No. 2014-261760 filed in Japan on Dec. 25, 2014, the entire contents of which are hereby incorporated by reference.

### BACKGROUND OF THE INVENTION

1. Field of the Invention

The present invention relates to a golf ball material which is highly suitable for use as an intermediate layer material or cover material in golf balls. The invention relates in particular to a golf ball material which endows the golf ball with excellent rebound and durability, and moreover is able to increase ball productivity, and to a method of manufacturing such a golf ball material.

2. Prior Art

Ionomers have hitherto been suitably used as golf ball materials. In recent years, methods carried out with ionomers have included methods in which different ionomers are blended together, methods in which other thermoplastic resins and additives are blended with an ionomer, and methods that involve rendering an ionomer itself into a more highly neutralized form. Methods for blending together different ionomers that have been proposed include art in which two types of ionomers of differing weight-average molecular weights are used in combination. For example, U.S. Pat. No. 7,462,113 describes the use of two types of ternary ionomers, each having a weight-average molecular weight In a specific range, as the base resin for a cover material. In addition, U.S. Pat. Nos. 7,273,903 and 7,488,778 describe the use of a resin composition obtained by blending together a ternary ionomer having a weight-average molecular weight in a specific range, a binary ionomer having a weight-average molecular weight in a specific range and, optionally, a thermoplastic elastomer.

However, in such art relating to ionomer blends, the degree of freedom in elements of the compounding design, such as the types of metal ions, the amounts in which the respective ionomers are included and their degrees of neutralization, is narrow, which has made it difficult to obtain the desired properties. In addition, several disclosures have been made concerning the use of highly neutralized materials obtained by increasing the degree of ionomer neutralization, but the hardness of such materials tends to be high, which has often made it difficult to obtain the desired rebound resilience and hardness.

Also, in terms of golf ball productivity, there exists a strong desire to efficiently mass produce quality golf balls in a short period of time. In a golf ball material, the ingredients of the resin composition are kneaded together using various types of extruders, then the composition is injection-molded under specific temperature and pressure conditions to produce a molded resin material having the desired hardness and other properties which is often used as the intermediate layer or cover (outermost layer) of a golf ball. In such injection molding, the moldability and flowability of the resin material often exerts an influence on the golf ball quality and productivity.

Many disclosures relating to ionomer-based blended resin materials have hitherto been made in which organic acids (including both fatty acids and derivatives thereof) with molecular weights in a specific range are included so as to increase the flowability of the resin material. However, when a large amount of organic acid metal salts (metal soaps) is added to a base resin such as an ionomer resin, organic acids such as fatty acids that form due to decomposition of the organic acid metal salts during injection molding vaporize, generating a large amount of gas. When a large amount of gas evolves in this way during injection molding, not only do molding defects arise, the paintability and other properties of the molded product are adversely affected by gaseous ingredients which adhere to the surface of the molded product. Moreover, an area of concern for some time now has been the fact that such cover materials obtained by the addition of a large amount of organic acid metal salts to an ionomer resin may incur a marked loss of moldability and resilience.

It is therefore an object of this invention to provide a golf ball material which, when injection-molded and used as the intermediate layer or cover (outermost layer) of a golf ball, endows the golf ball with excellent rebound and durability, and moreover is able to increase the golf ball productivity. Another object of the invention is to provide a method of manufacturing such a golf ball material.

### SUMMARY OF THE INVENTION

As a result of extensive investigations, we have discovered that, by focusing on, for example, the ester content, type of acid, acid content and weight-average molecular weight of the base resin in a golf ball material, and moreover by adjusting within specific ranges the amounts of neutralizable basic inorganic metal compounds and fatty acids included in the base resin, it is possible both to maintain a good golf ball rebound and durability, and also, because the resin material during molding has a good flowability and the problem of molding defects due to gas generation and the like is minimized, to increase the golf ball productivity.

Accordingly, in a first aspect, the invention provides a golf ball material which contains a resin composition that includes:
a combined amount of 100 parts by weight of the following two base resins A and B

(A) an olefin-unsaturated carboxylic acid-unsaturated carboxylic acid ester ternary copolymer, or a metal neutralization product thereof, having a weight-average molecular weight (Mw) of at least 140,000, an acid content of from 10 to 15 wt % and an ester content of at least 15 wt %, and

(B) an olefin-acrylic acid random binary copolymer, or a metal neutralization product thereof, having a weight-average molecular weight (Mw) of at least 140,000 and an acid content of from 10 to 15 wt %
blended in a weight ratio (A):(B) of from 90:10 to 10:90;

(C) from 1.0 to 2.5 parts by weight of a basic inorganic metal compound capable of neutralizing unneutralized acid groups in the resin composition; and

(D) from 1 to 100 parts by weight of an anionic surfactant having a molecular weight of from 140 to 1,500.
Components A and B each have a melt flow rate (MFR) of from 0.5 to 20 g/10 min, and the MFR difference between component A and component B is not more than 15 g/10 min. The resin composition of components A to D has a melt flow rate of at least 1.0 g/10 min, and a molded product obtained by molding the resin composition under applied heat has a hardness, expressed in terms of Shore D hardness, of from 35 to 60.

In a preferred embodiment, the golf ball material of the invention further includes (E) from 1 to 50 parts by weight of a non-ionomeric thermoplastic elastomer per 100 parts by weight of the combined amount of the base resins.

In another preferred embodiment, the golf ball material of the invention further includes (F) from 0.1 to 15.0 parts by weight of a compound having two or more reactive functional groups and a molecular weight of not more than 20,000 per 100 parts by weight of the combined amount of the base resins.

In the inventive golf ball material, component C and component D preferably have a compounding ratio therebetween, expressed as a weight ratio, of from 4.0:96.0 to 1.0:99.0.

The golf ball material of the invention preferably has, in thermogravimetric analysis, a percent loss of weight at 250° C., based on the weight at 25° C., of not more than 4.0 wt %.

The golf ball material of the invention is preferably adapted for use as a cover material in a two-piece solid golf ball having a core and a cover encasing the core, or as an intermediate layer material or a cover material in a multi-piece solid golf ball having a core of at least one layer, at least one intermediate layer encasing the core, and a cover of at least one layer encasing the intermediate layer.

In a second aspect, the invention provides a method of manufacturing a golf ball material which includes the steps of kneading a resin composition that includes the following components (A) to (D) with an extruder:
a combined amount of 100 parts by weight of the following two base resins A and B

(A) an olefin-unsaturated carboxylic acid-unsaturated carboxylic acid ester ternary copolymer, or a metal neutralization product thereof, having a weight-average molecular weight (Mw) of at least 140,000, an acid content of from 10 to 15 wt % and an ester content of at least 15 wt %, and

(B) an olefin-acrylic acid random binary copolymer, or a metal neutralization product thereof, having a weight-average molecular weight (Mw) of at least 140,000 and an acid content of from 10 to 15 wt %
blended in a weight ratio (A):(B) of from 90:10 to 10:90,

(C) from 1.0 to 2.5 parts by weight of a basic inorganic metal compound capable of neutralizing unneutralized acid groups in the resin composition, and

(D) from 1 to 100 parts by weight of an anionic surfactant having a molecular weight of from 140 to 1,500; and injection-molding the kneaded composition of components A to D under conditions where the composition has a melt flow rate of at least 1.0 g/10 min to obtain a molded resin material having a Shore D hardness of from 35 to 60.

In the manufacturing method of the invention, the compounding ratio between component C and component D, expressed as a weight ratio, is preferably from 4.0:96.0 to 1.0:99.0.

In the manufacturing method of the invention, it is preferable for the extruder to be a twin-screw extruder and for the kneading temperature to be regulated within the range of 50° C. to 250° C.

The golf ball material of the invention, along with being able to maintain a good ball rebound and durability, has a good flowability during molding and minimizes molding defects due to gas evolution, enabling golf ball productivity to be increased. Accordingly, the golf ball material of the invention is very useful as an intermediate layer material or cover material in golf balls for which a good rebound and durability are desired.

### DETAILED DESCRIPTION OF THE INVENTION

The objects, features and advantages of the invention will become more apparent from the following detailed description.

The golf ball material of the invention uses the following two types of base resins A and B.
Component A: An olefin-unsaturated carboxylic acid-unsaturated carboxylic acid ester ternary copolymer, or a metal neutralization product thereof, having a weight-average molecular weight (Mw) of at least 140,000, an acid content of from 10 to 15 wt % and an ester content of at least 15 wt %; and
Component B: An olefin-acrylic acid binary random copolymer, or a metal neutralization product thereof, having a weight-average molecular weight (Mw) of at least 140,000 and an acid content of from 10 to 15 wt %

The weight-average molecular weight (Mw) of component A is at least 140,000, and preferably at least 145,000. The weight-average molecular weight (Mw) of component B is at least 140,000, and preferably at least 160,000. By thus making these molecular weights large, the resin material can be assured of having a sufficient resilience.

It is thought that because the acid components and ester contents of the respective copolymers serving as base resins A and B differ, these two types of base resins interlock in a complex manner, giving rise to molecular synergistic effects that can increase the rebound and durability of the ball. In this invention, by specifying the weight-average molecular weight, acid content and ester content as indicated above in such a way as to select a material that is relatively soft as base resin A, which is a ternary copolymer, and specifying the types of acid, weight-average molecular weight and acid content in such a way as to select a relatively hard material as base resin B, it is possible with a blend of these polymers to ensure a sufficient resilience and durability for use as a golf ball material.

Here, the weight-average molecular weight (Mw) is a value calculated relative to polystyrene in gel permeation chromatography (GPC). A word of explanation is needed here concerning GPC molecular weight measurement. It is not possible to directly take GPC measurements for binary and ternary copolymers because these molecules are adsorbed to the GPC column owing to unsaturated carboxylic acid groups within the molecules. Instead, the unsaturated carboxylic acid groups are generally converted to esters, following which GPC measurement is carried out and the polystyrene-equivalent average molecular weights Mw and Mn are calculated.

The olefin used in component A and component B preferably has 2 to 6 carbons, with ethylene being especially preferred. The unsaturated carboxylic acid used in component A is not particularly limited, although preferred use can be made of acrylic acid or methacrylic acid. To ensure resilience, the unsaturated carboxylic acid used in component B is acrylic acid. The reason is that when methacrylic acid is used as the unsaturated carboxylic acid in component B, the methacrylic acid with its pendant methyl group may give rise to a buffering action, lowering the reactivity.

The unsaturated carboxylic acid content (acid content) within each of components A and B, although not particularly limited, is preferably at least 10 wt %, with the upper limit being preferably less than 15 wt %, and more preferably less than 13 wt %. When this acid content is low, moldings of the golf ball material may lack sufficient resilience. On the other hand, when the acid content is high, the hardness may become extremely high, adversely affecting the durability.

The unsaturated carboxylic acid ester used in component A, which is a ternary copolymer, is preferably a lower alkyl ester, with butyl acrylate (butyl n-acrylate, butyl i-acrylate) being especially preferred.

In order to use component A as a resin that is relatively soft compared with the binary copolymer serving as component B, the ester content of the unsaturated carboxylic acid ester in component A is set to at least 15 wt %, preferably at least 18 wt %, and more preferably at least 20 wt %, with the upper limit being preferably not more than 25 wt %. When the ester content is higher than this range, moldings of the golf ball material may lack sufficient resilience. On the other hand, when the ester content is low, the hardness may become high, adversely affecting the durability.

The hardness of the base resin (A), that is, the hardness when this resin itself is molded alone (material hardness), expressed in terms of Shore D hardness, is preferably at least 30, and more preferably at least 35, with the upper limit being preferably not more than 50, and more preferably not more than 45. The hardness of base resin (B), that is, the hardness when this resin itself is molded alone (material hardness), expressed in terms of Shore D hardness, is preferably at least 40, and more preferably at least 50, with the upper limit being preferably not more than 60, and even more preferably not more than 57. When base resins outside of these hardness ranges are used, a material having the desired hardness may not be obtained, or a sufficient resilience and durability may not be obtained.

In this invention, it is critical for component A and component B to be used together. The mixing proportions of component A and component B, expressed as the weight ratio (A):(B), is set to preferably from 90:10 to 10:90, more preferably from 80:20 to 30:70, and even more preferably from 70:30 to 50:50. When the proportion of component B is larger than this range, the hardness increases, as a result of which molding of the material may be difficult to carry out.

In cases where metal neutralization products of resins (i.e., ionomers) are used as component A and component B, the type of metal neutralization product and degree of neutralization are not particularly limited. Illustrative examples include 60 mol % Zn (degree of neutralization with zinc) ethylene-methacrylic acid copolymers, 40 mol % Mg (degree of neutralization with magnesium) ethylene-methacrylic acid copolymers, and 40 mol % Mg (degree of neutralization with magnesium) ethylene-methacrylic acid-acrylic acid ester terpolymers.

To ensure at least a given degree of flowability during injection molding and provide a good molding processability, it is critical for the melt flow rates (MFR) of the resins serving as components A and B to each be from 0.5 to 20 g/10 min. Also the difference between the melt flow rates of components A and B is set to not more than 15 g/10 min. When the difference in MFR between these base resins is too large, these components cannot be uniformly mixed together during compounding of components A and B in an extruder, and so the mixture becomes non-uniform, which may lead to injection molding defects.

As mentioned above, copolymers or ionomers with weight-average molecular weights (Mw) set in specific ranges are used as components A and B. Illustrative examples of commercial products that may be used for this purpose include the Nucrel series (DuPont-Mitsui Polychemicals Co., Ltd.), the Escor series (ExxonMobil Chemical), the Surlyn series (E.I. DuPont de Nemours & Co.), and the Himilan series (DuPont-Mitsui Polychemicals Co., Ltd.).

Next, component C is described. Component C is a basic inorganic metal compound which is capable of neutralizing un-neutralized acid groups in the resin composition. Illustrative examples of the metal ions in the basic inorganic metal compound include Na⁺, K⁺, Li⁺, Zn²⁺, Ca²⁺, Mg²⁺, Cu²⁺ and Co²⁺. Of these, Na⁺, Zn²⁺, Ca²⁺ and Mg²⁺ are preferred, and Mg²⁺ is more preferred. These metal salts may be introduced into the resin using, for example, formates, acetates, nitrates, carbonates, bicarbonates, oxides and hydroxides.

This basic inorganic metal compound (C) is a component for neutralizing acid groups in above components A and B and subsequently described component D. This compound is included in an amount equivalent to at least 70 mol %, based on the acid groups in the resin composition. Here, the amount in which the basic inorganic metal compound serving as component C is included may be selected as appropriate for obtaining the desired degree of neutralization. Although this amount depends also on the degree of neutralization of the base resins (components A and B) that are used, in general it is preferably from 1.0 to 2.5 parts by weight, more preferably from 1.1 to 2.3 parts by weight, and even more preferably from 1.2 to 2.0 parts by weight, per 100 parts by weight of the combined amount of the base resins (components A and B). The degree of neutralization of the acid groups in components A to D is preferably at least 70 mol %, more preferably at least 90 mol %, and even more preferably at least 100 mol %.

Next, the anionic surfactant serving as component D is described. The reason for including a suitable amount of an anionic surfactant in the base resin is to improve the durability after resin molding while ensuring good flowability of the overall resin composition. The anionic surfactant is not particularly limited, although the use of one having a molecular weight of from 140 to 1,500 is preferred. Anionic surfactants include carboxylate surfactants, sulfonate surfactants, sulfate ester surfactants and phosphate ester surfactants. Illustrative examples include various fatty acids such as stearic acid, behenic acid, oleic acid and maleic acid, as well as derivatives thereof. One, two or more types selected from the group consisting of metal salts of these are preferred. Selection from the group consisting of stearic acid, oleic acid and mixtures thereof is especially preferred. Alternatively, the organic acid metal salt of component D may be a metal soap, with the metal salt being one in which a metal ion having a valence of 1 to 3 is used. The metal is preferably one selected from the group consisting of lithium, sodium, magnesium, aluminum, potassium, calcium and zinc, with the use of metal salts of stearic acid being especially preferred. Specifically, the use of magnesium stearate, calcium stearate, zinc stearate or sodium stearate is preferred.

Component D is included in an amount, per 100 parts by weight of the base resins serving as components A and B, of from 1 to 100 parts by weight, preferably from 10 to 85 parts by weight, and more preferably from 20 to 65 parts by weight. When the component D content is too low, reducing the hardness of the resin material may be difficult. On the other hand, at a high content, the resin material is difficult to mold and bleeding at the material surface increases, adversely affecting the molded article.

In this invention, the moldability of the material and the productivity can be further increased by adjusting the compounding ratio between components C and D. When the content of the basic inorganic metal compound serving as component C is too large, the amount of gas consisting of organic acids and other substances that evolves during molding decreases, but the flowability of the material diminishes. Conversely, when the content of component C is small, the amount of gasification increases. When the content of the anionic surfactant serving as component D increases, gases of organic acids such as fatty acids increase during molding, which exerts a large influence on molding defects and productivity. Conversely, when the content of component D is low, the amount of gases generated decreases, but the flowability and durability decline. Therefore, a compounding balance between components C and D is also important. Specifically, it is desirable to set the compounding ratio between components C and D, expressed as the weight ratio (C):(D), to from 4.0:96.0 to 1.0:99.0, and especially from 3.0:97.0 to 1.5:98.5.

The resin composition of above components A to D accounts for preferably at least 50 wt %, more preferably at least 60 wt %, even more preferably at least 70 wt %, and most preferably at least 90 wt %, of the total amount of the golf ball material.

A non-ionomeric thermoplastic elastomer (E) may be included in the golf ball material of the invention. When including component E, this may be added within a range that does not detract from the effects of the invention. It is especially preferable to include from 1 to 50 parts by weight of component E per 100 parts by weight of the combined amount of the base resins.

The non-ionomeric thermoplastic elastomer (E) is exemplified by polyolefin elastomers (including polyolefins and metallocene-catalyzed polyolefins), polystyrene elastomers, diene polymers, polyacrylate polymers, polyimide elastomers, polyurethane elastomers, polyester elastomers and polyacetals.

In addition, (F) a compound having two or more reactive functional groups and a molecular weight of not more than 20,000 may be included in the golf ball material. Monomers, oligomers, macromonomers and the like having a total of two or more reactive functional groups of one, two or more types per molecule and a molecular weight of not more than 20,000, and preferably not more than 5,000, may be used as component F. There is no particular upper limit in the number of reactive functional groups, although this is generally six or fewer.

Here, “monomer” refers to a monomer molecule. “Oligomer” refers to a low-molecular-weight product obtained from the monomers typically used in polymer synthesis, and generally includes dimers and higher n-mers with molecular weights up to several thousand. “Macromonomer” refers to an oligomer having polymerizable functional groups on the ends. Macromonomers are materials which, by copolymerization with various functional comonomers, are used in the synthesis of graft polymers. They have molecular weights of generally from several thousands to several tens of thousands. These are generally used as intermediate materials in the synthesis of plastics and elastomers, and as starting materials for graft polymers. Oligomers and macromonomers possessing various functions have attracted attention in recent years.

The reactive functional groups alluded to above are not particularly limited, provided they are capable of improving adhesion between members of a golf ball. For example, hydroxyl groups, amino groups, carboxyl groups and epoxy groups are especially preferred as reactive functional groups. In the case of blends with an ionomer resin, hydroxyl groups are especially preferred because they have little influence on the melt flow rate (MFR).

Illustrative examples of monomers include 1,3-butanediol, 1,6-hexanediol, trimethylolpropane, mannitol, sorbitol and polysaccharides. Examples of oligomers and macromonomers include, but are not limited to, polyethylene glycol, polyhydroxy polyolefin oligomers, modified low-molecular-weight polyethylenes, modified low-molecular-weight polypropylenes, modified low-molecular-weight polystyrenes and modified liquid rubbers. The use of polyhydroxy polyolefin oligomers and trimethylolpropane is especially preferred. These may be used singly or two or more may be used together.

A commercially available product may be used as the monomer, oligomer or macromonomer. Examples include trimethylolpropane available from Mitsubishi Gas Chemical Co., Inc., and polyhydroxy polyolefin oligomers available under the trade name Polytail H from Mitsubishi Chemical Corporation (number of side chain carbons, 150 to 200; with hydroxyl groups on the ends).

The content of component F per 100 parts by weight of the combined amount of the base resins, although not particularly limited, is preferably from 0.1 to 15 parts by weight, more preferably form 0.3 to 12 parts by weight, and even more preferably from 0.5 to 10.0 parts by weight. When the amount of addition is too small, a sufficient compounding effect may not be obtained. On the other hand, when too much is added, this may lower the properties of the golf ball.

Optional additives may be suitably included in the golf ball material of the invention according to the intended use. For example, when the inventive golf ball material is used as a cover material, various additives such as pigments, dispersants, antioxidants, ultraviolet absorbers and liquid stabilizers may be added to components A to D. When such additives are included, the content thereof per 100 parts by weight of components A to D combined is preferably at least 0.1 part by weight, and more preferably at least 0.5 part by weight, with the upper limit being preferably not more than 10 parts by weight, and more preferably not more than 4 parts by weight.

The melt flow rate of the golf ball material of the invention, as measured in accordance with JIS-K7210 at a test temperature of 190° C. and a test load of 21.18 N (2.16 kgf), is not particularly limited. However, to obtain a good flowability and molding processability during injection molding, it is recommended that this be preferably at least 1.0 g/10 min, more preferably at least 1.1 g/10 min, and even more preferably at least 1.5 g/10 min, with the upper limit being preferably not more than 4.0 g/10 min, and more preferably not more than 2.7 g/10 min.

The Shore D hardness of molded products obtained using the golf ball material of the invention is at least 35, preferably at least 40, and more preferably at least 45, with the upper limit being not more then 60, and preferably not more than 57.

This golf ball material may be subjected to thermogravimetric analysis, the results of which serve as an indicator of moldability and productivity. In thermogravimetric analysis of the resin material, it is recommended that the percent loss of weight at 250° C., based on the weight at 25° C., be preferably not more than 4.0 wt %, more preferably not more than 3.7 wt %, and even more preferably not more than 3.4 wt %. The measurement conditions involve carrying out thermogravimetric analysis in a nitrogen atmosphere (flow rate, 50 mL/min) and from 25° C. to 250° C. at a temperature rise rate of 3° C./min so as to determine the percent loss of weight at 250° C. with respect to the weight at 25° C. Gases that evolve during molding are presumably low-molecular-weight ingredients such as free fatty acids in the resin composition, and decomposition products. It is thought that, by reducing the amount of such gasification, molding defects such as trapped air, weld lines and scorching can be suppressed, improving the moldability and productivity of golf balls.

The method used to manufacture the golf ball material of the invention, although not particularly limited, may be one which involves, for example, charging the following ingredients together into a hopper: ionomeric or un-neutralized polymer components A and B as the base resin components, component C and component D, then extruding the resulting blend under the desired conditions. Alternatively, component D may be charged from a separate feeder. In this case, neutralization reactions on the carboxylic acids in components A, B and D by component C serving as the metal cation source can be carried out by various types of extruders. The extruder may be either a single-screw extruder or a twin-screw extruder, although a twin-screw extruder is more preferred. These extruders may be used in a tandem arrangement, examples of which include a single-screw extruder/twin-screw extruder and a twin-screw extruder/twin-screw extruder.

The golf ball material of the invention may be used as a cover material in a two-piece solid golf ball composed of a core and a cover encasing the core, or as a cover material or an intermediate layer material in a multi-piece solid golf ball composed of a core of at least one layer, an intermediate layer of at least one layer encasing the core, and a cover of at least one layer encasing the intermediate layer. Particularly in cases where the golf ball is a multilayer golf ball having a core of at least one layer and a cover of at least two layers, golf balls of an even better resilience and durability can be obtained when the core is formed of a rubber composition containing cis-1,4-polybutadiene, an unsaturated carboxylic acid metal salt, an inorganic filler and an organic peroxide, the material of the invention is preferably used to form an inner cover layer (intermediate layer) which is not the outermost layer cover, and a conventional ionomer resin or a conventional polyurethane elastomer is used to form the cover.

### EXAMPLES

The following Examples and Comparative Examples are provided to illustrate the invention, and are not intended to limit the scope thereof.

### Examples 1 to 4, Comparative Examples 1 to 7

Cores having a diameter of 37.3 mm and a weight of 32.7 g were obtained using a core material formulated as shown below and composed primarily of cis-1,4-polybutadiene.

### Core Formulation

| | |
|---|---|
| cis-1,4-Polybutadiene (BR01, from | 100.0 parts by weight |
| JSR Corporation) | |
| Zinc oxide | 4.0 parts by weight |
| Barium sulfate | 18.4 parts by weight |
| Antioxidant (Nocrac NS-6, Ouchi | 0.2 parts by weight |
| Shinko Chemical Industry Co., Ltd.) | |
| Zinc acrylate | 28.5 parts by weight |
| Dicumyl peroxide | 1.0 parts by weight |
| Water | 0.4 parts by weight |
| Zinc salt of pentachlorothiophenol | 0.1 parts by weight |

Next, intermediate layer materials having the compositions shown in Table 1 were mixed at 200° C. in a kneading-type twin-screw extruder, giving intermediate layer materials in pellet form, following which these were injected into molds in which the solid cores had been placed, thereby producing spheres encased by an intermediate layer with a thickness of 1.35 mm.

Next, using a cover composition obtained by blending Himilan® 1605 and Himilan® 1706 in a 50:50 weight ratio as the outermost layer material (cover material), injection-molding was carried out over the intermediate layer, giving three-piece solid golf balls having the diameter shown in Table 1.

The properties of the golf balls obtained in the respective Working Examples and Comparative Examples were evaluated as indicated below. The results are presented in Table 1.

TABLE 1

| | | | Example | | | | Comparative Example | | | | | | |
|---|---|---|---|---|---|---|---|---|---|---|---|---|---|
| | | | 1 | 2 | 3 | 4 | 1 | 2 | 3 | 4 | 5 | 6 | 7 |
| Intermediate | Component A | Resin (A-1) | 70 | | | | 100 | | | | | | |
| layer | | Resin (A-2) | | 70 | 80 | 70 | | | 70 | 70 | | | |
| formulation | | Resin (A-3) | | | | | | 100 | | | 100 | | |
| (pbw) | Component B: Resin (B-1) | | 30 | 30 | 20 | 30 | | | 30 | 30 | | | |
| | Component C | Magnesium | 1.25 | 1.12 | 1.40 | 1.50 | 0.80 | 1.90 | 1.12 | 2.60 | | | |
| | | oxide | | | | | | | | | | | |
| | | Calcium | | | | | | | | | 2.54 | | |
| | | hydroxide | | | | | | | | | | | |
| | Component D | Magnesium | 60 | 60 | 60 | 80 | 60 | 70 | 120 | 60 | | | |
| | | stearate | | | | | | | | | | | |
| | | Calcium | | | | | | | | | 70 | | |
| | | stearate | | | | | | | | | | | |

| | | | | | | | | | | | | |
|---|---|---|---|---|---|---|---|---|---|---|---|---|
| | Resin X | | | | | | | | | | 100 | |
| | Resin Y | | | | | | | | | | | 100 |
| Resin | Amount of gas evolution | 3.2 | 3.4 | 1.9 | 3.4 | 3.6 | 2.2 | 4.7 | 0.4 | 1.1 | 2.9 | 3.9 |
| properties | (wt %) | | | | | | | | | | | |
| | Melt flow rate | 1.1 | 1.1 | 1.0 | 2.2 | 2.1 | 2.0 | 2.4 | * | 0.3 | 0.7 | 1.0 |
| | (g/10 min) | | | | | | | | | | | |
| | Productivity | good | good | good | good | good | good | NG | NG | NG | NG | good |
| | Shore D hardness | 52.0 | 52.1 | 51.5 | 52.2 | 53.9 | 50.5 | 53.4 | * | 55.2 | 51.4 | 47.4 |
| Ball | Diameter (mm) | 42.7 | 42.7 | 42.7 | 42.7 | 42.7 | 42.7 | 42.7 | ** | 42.7 | 42.7 | 42.7 |
| properties | Deflection (mm) | 3.22 | 3.25 | 3.27 | 3.24 | 3.24 | 3.29 | 3.14 | ** | 2.90 | 3.30 | 3.41 |
| | Initial velocity (m/s) | 77.07 | 77.10 | 77.07 | 77.16 | 76.87 | 76.88 | 77.22 | ** | 76.54 | 77.10 | 76.92 |
| | Durability | 123 | 122 | 115 | 118 | 125 | 114 | 112 | ** | 133 | 106 | 99 |

* The melt flow rate was low, making measurement impossible.
** Ball could not be molded due to a low melt flow rate.

Details on the intermediate layer materials in the table are shown below. Numbers for the amounts of the intermediate layer materials in the table are in parts by weight.

### Resin (A-1): Surlyn® 8320

A metal salt of an ethylene-methacrylic acid-acrylic acid ester terpolymer (E.I. DuPont de Nemours & Co.); Mw, 146,000; acid content, 10 wt %; ester content, 23 wt %; MFR, 1.0 g/10 min; Shore D hardness, 41.

### Resin (A-2): Surlyn® 9320

A metal salt of an ethylene-methacrylic acid-acrylic acid ester terpolymer (E.I. DuPont de Nemours & Co.); Mw, 164,000; acid content, 10 wt %; ester content, 23 wt %; MFR, 0.8 g/10 min; Shore D hardness, 40.

### Resin (A-3): Nucrel® AN 4319

An un-neutralized ethylene-methacrylic acid-acrylic acid ester terpolymer (DuPont-Mitsui Polychemicals Co., Ltd.); Mw, 127,000; acid content, 8 wt %; ester content, 17 wt %; MFR, 60 g/10 min; Shore D hardness, 30.

### Resin (B-1): Nucrel® AN 4221C

An un-neutralized ethylene-methacrylic acid copolymer (DuPont-Mitsui Polychemicals Co., Ltd.); Mw, 181,000; acid content, 12 wt %; MFR, 10 g/10 min; Shore D hardness, 55.

The molecular weights and molecular weight distributions of the above polymers were obtained by measurement using gel permeation chromatography (GPC) and calculation relative to polystyrene.
Magnesium oxide: “Kyowamag MF 150” from Kyowa Chemical Industry Co., Ltd.
Calcium hydroxide: “CLS-B” from Shiraishi Calcium Kaisha, Ltd.
Magnesium stearate: “Magnesium Stearate G” from NOF Corporation
Calcium stearate: “Calcium Stearate G” from NOF Corporation

### Resin X: HPF 1000

HPF 1000: DuPont HPF™ 1000. A terpolymer composed of about 75 to 76 wt % ethylene, about 8.5 wt % acrylic acid, and 15.5 wt % to about 16.5 wt % n-butyl acrylate. 100% of the acid groups are neutralized with magnesium ions.

### Resin Y: HPF 2000

HPF 2000: DuPont HPF™ 2000. 100% of the acid groups are neutralized with magnesium ions.

The methods used to measure the properties of the golf ball materials and golf balls are described below.

### Amount of Gas Evolution

Thermogravimetry from 25° C. to 250° C. was carried out at a temperature rise rate of 3° C./min in a nitrogen atmosphere (flow rate, 50 mL/min) for about 10 mg of each sample, and the percent weight loss at 250° C. relative to the weight at 25° C. was determined. This weight loss was assumed to be the amount of gas that evolved.

### Melt Flow Rate (MFR)

The melt flow rate value (g/10 min) was measured in accordance with JIS-K 7210 at a temperature of 190° C. and under a load of 21.18 N (2.16 kgf).

### Productivity

The productivity when molding the intermediate layer was rated according to the following criteria.
Good: Incidence of trapped air, weld lines and eccentricity was less than 3%.
NG: Incidence of trapped air, weld lines and eccentricity was 3% or more, or molding was impossible due to poor flowability.

### Material Hardness (Shore D)

The composition was molded into 2 mm thick sheets, three of which were stacked together, and the hardness was measured with a Shore D durometer.

### Deflection (mm)

The golf ball was placed on a steel plate and the amount of deflection (mm) when compressed under a final load of 1,275 N (130 kgf) from an initial load of 98 N (10 kgf) was measured.

Initial Velocity (m/s)

The initial velocity of the ball was measured using an initial velocity measuring apparatus of the same type as the USGA drum rotation-type initial velocity instrument approved by the R&A. The balls were held isothermally in a 23±1° C. environment for at least 3 hours and then tested at the same temperature. Each ball was hit using a 250-pound (113.4 kg) head (striking mass) at an impact velocity of 143.8 ft/s (43.83 m/s). Ten balls were each hit twice. The time taken for the ball to traverse a distance of 6.28 ft (1.91 m) was measured and used to compute the initial velocity (m/s). This cycle was carried out over a period of about 15 minutes.

### Durability

The durability of the golf ball was evaluated using an ADC Ball COR Durability Tester produced by Automated Design Corporation (U.S.). This tester fires a golf ball pneumatically and causes it to repeatedly strike two metal plates arranged in parallel. The durability was evaluated using the average number of shots required for a golf ball to crack. Average values were obtained by furnishing four balls of the same type for testing, repeatedly firing each of the four balls until it cracked, and averaging the number of shots required for the four balls to crack. The type of tester used was a vertical COR durability tester, and the incident velocity of the balls on the metal plates was set to 43 m/s.

As is apparent from the results in Table 1, the Comparative Examples were inferior to the Working Rxamples in the following respects.

In Comparative Example 1, a base resin corresponding to component B of the invention was not included in the resin composition of the intermediate layer material. As a result, a sufficient ball initial velocity was not obtained.

In Comparative Example 2, a base resin corresponding to component B of the invention was not included in the resin composition of the intermediate layer material. As a result, a sufficient ball initial velocity was not obtained.

In Comparative Example 3, the amount of the anionic surfactant (D) included in the resin composition of the intermediate layer material was 120 parts by weight with respect to the base resin, which is high. As a result, trapped air and weld line defects during molding of the intermediate layer were numerous and the productivity was poor.

In Comparative Example 4, the amount of the basic inorganic metal compound (C) included in the resin composition of the intermediate layer material was high. As a result, the resin material had a poor flowability during molding, and so the golf ball productivity was poor (the balls could not be molded).

In Comparative Example 5, the amount of component C was high. As a result, the flowability of the resin material during molding was poor, and so the golf ball productivity was poor.

In Comparative Example 6, the flowability of the intermediate layer material was poor, and so the productivity was poor.

In Comparative Example 7, the intermediate layer material did not have a sufficient resilience, the durability was poor, and the initial velocity was inadequate.

Japanese Patent Application No. 2014-261760 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball material comprising a resin composition which comprises:
a combined amount of 100 parts by weight of the following two base resins A and B
(A) an olefin-unsaturated carboxylic acid-unsaturated carboxylic acid ester ternary copolymer, or a metal neutralization product thereof, having a weight-average molecular weight (Mw) of at least 140,000, an acid content of from 10 to 15 wt % and an ester content of at least 15 wt %, and
(B) an olefin-acrylic acid random binary copolymer, or a metal neutralization product thereof, having a weight-average molecular weight (Mw) of at least 140,000 and an acid content of from 10 to 15 wt %
blended in a weight ratio (A):(B) of from 90:10 to 10:90;
(C) from 1.0 to 2.5 parts by weight of a basic inorganic metal compound capable of neutralizing unneutralized acid groups in the resin composition; and
(D) from 1 to 100 parts by weight of an anionic surfactant having a molecular weight of from 140 to 1,500,
wherein components A and B each have a melt flow rate (MFR) of from 0.5 to 20 g/10 min, the MFR difference between component A and component B is not more than 15 g/10 min, the resin composition of components A to D has a melt flow rate of at least 1.0 g/10 min, and a molded product obtained by molding the resin composition under applied heat has a hardness, expressed in terms of Shore D hardness, of from 35 to 60.

2. The golf ball material according to claim 1, further comprising (E) from 1 to 50 parts by weight of a non-ionomeric thermoplastic elastomer per 100 parts by weight of the combined amount of the base resins.

3. The golf ball material according to claim 1, further comprising (F) from 0.1 to 15.0 parts by weight of a compound having two or more reactive functional groups and a molecular weight of not more than 20,000 per 100 parts by weight of the combined amount of the base resins.

4. The golf ball material according to claim 1, wherein component C and component D have a compounding ratio therebetween, expressed as a weight ratio, of from 4.0:96.0 to 1.0:99.0.

5. The golf ball material according to claim 1 which has, in thermogravimetric analysis, a percent loss of weight at 250° C., based on the weight at 25° C., of not more than 4.0 wt %.

6. The golf ball material according to claim 1 which is adapted for use as a cover material in a two-piece solid golf ball comprising a core and a cover encasing the core, or as an intermediate layer material or a cover material in a multi-piece solid golf ball comprising a core of at least one layer, at least one intermediate layer encasing the core, and a cover of at least one layer encasing the intermediate layer.

7. A method of manufacturing a golf ball material, comprising the steps of:
kneading a resin composition comprising the following components (A) to (D) with an extruder:
a combined amount of 100 parts by weight of the following two base resins A and B
(A) an olefin-unsaturated carboxylic acid-unsaturated carboxylic acid ester ternary copolymer, or a metal neutralization product thereof, having a weight-average molecular weight (Mw) of at least 140,000, an acid content of from 10 to 15 wt % and an ester content of at least 15 wt %, and
(B) an olefin-acrylic acid random binary copolymer, or a metal neutralization product thereof, having a weight-average molecular weight (Mw) of at least 140,000 and an acid content of from 10 to 15 wt
blended in a weight ratio (A):(B) of from 90:10 to 10:90,
(C) from 1.0 to 2.5 parts by weight of a basic inorganic metal compound capable of neutralizing unneutralized acid groups in the resin composition, and
(D) from 1 to 100 parts by weight of an anionic surfactant having a molecular weight of from 140 to 1,500; and injection-molding the kneaded composition of components A to D under conditions where the composition has a melt flow rate of at least 1.0 g/10 min to obtain a resin molded product having a Shore D hardness of from 35 to 60.

8. The manufacturing method according to claim 7, wherein the compounding ratio between component C and component D, expressed as a weight ratio, is from 4.0:96.0 to 1.0:99.0.

9. The manufacturing method according to claim 7, wherein the extruder is a twin-screw extruder and the kneading temperature is regulated within the range of 50° C. to 250° C.
